(19) United States
(12) Patent Application Publication
(10) Pub. No.: US 2008/0022498 A1
(43) Pub. Date: Jan. 31, 2008

(54) Clasp Apparatus Having Connector Clasp and Safety Clasp

(76) Inventor: Stanley Griffith, Proctorville, OH (US)

Correspondence Address: ROBERT R. WATERS, ESQ.;WATERS LAW OFFICE, PLLC, 633 SEVENTH STREET, HUNTINGTON, WV, 25701, US

(21) Appl. No.: 11/460,451

(22) Filed: Jul. 27, 2006

(51) Int. Cl. F16B 45/00

(52) U.S. Cl. 24/598.7

(57) ABSTRACT

A clasp or connector apparatus comprises a connector clasp having a selectively displaceable member, and a safety clasp coupled to the connector clasp externally adjacent to the displaceable member. The connector clasp comprises means for selectively displacing the member. The safety clasp comprises an arm selectively movable for coupling to a receiver coupled to the connector clasp, wherein arm is aligned parallel to the displaceable member of the connector clasp.

### RELATED U.S. APPLICATION DATA

Not applicable.

### BACKGROUND OF THE INVENTION

1. Field of the Invention

The present invention generally relates to clasps or connectors. Specifically, the present invention relates to a clasp or connector having a safety clasp coupled thereto.

2. Description of the Related Art

Several attempts to improve the integrity and security of jewelry clasps have been offered. While the spring ring (or spring-lock) clasp was popular for sometime, the spring ring clasp proved to be difficult to operate. In particular, the lever was uncomfortable to manipulate usually because of the small size and the rigidity. Because of the small size and rigidity, it is no simple task to release a spring ring clasp. Depending upon the dexterity and strength of the user, the lever may be difficult to urge back, or may impart sufficient force against the user's finger(s) to inflict temporary pain or injury upon the person. This may be an especially acute problem for the elderly having poor dexterity, strength and / or eyesight, or for those that have sustained injuries to the fingers, hands or wrists. As a result of this acknowledged problem, the other types of clasps have emerged as alternatives to the spring ring clasp, including the use of clasps that require less physical strength and dexterity to operate (such as box clasps with or without safety guards, toggle clasps, lobster claw clasps and push lock clasps).

Among the several improvements offered over the alternative clasps, one type that is particularly relevant are the hidden clasps having a safety guard. One example is illustrated in the non-patent reference material provided by About.com. As is illustrated, the primary clasp is a hidden clasp means with a outwardly biased tongue inserted into a channel so that the tongue is impinged therein when inserted into the channel. The safety guard (figure-eight latch and ball) is oriented in a plane approximately ninety degrees from the tongue and channel plane. Thus, if the tongue and channel combination fail, theoretically, the safety guard will operate as a sufficient back-up to maintain the coupling of the jewelry ends.

There are several references disclosed herein that describe the various elements of the present invention separately, but not in the combination provided by the inventor. This combination of elements is unanticipated and is not suggested or taught by the references in a manner that is obvious to one of ordinary skill in the art. In fact, attempts have been made to affix a safety guard element onto spring ring (spring-lock) clasps, but with considerable failure and frustration. When the safety guard (usually a figure-eight and ball type combination) are soldered to a spring ring clasp, the spring ring clasp becomes inoperable because one or several of the elements are deformed, which may include damage to the spring, the opening, the tongue or all the above. For this reason, it is unobvious that affixing a safety guard to a lobster claw clasp or a push lock clasp would be successful, and was unexpected based on the previous attempts known with regard to spring ring clasps and the like.

Among the many references, several are worth noting for providing a basis for understanding the prior art with regard to clasps, in general, and jewelry clasps, in particular. For instance, U.S. Publication No. 2006/0086144 (Williams) discloses the use of a connector clasp and a figure-eight type clasp in a unique combination. FIG. 7 and FIG. 8 depict two lobster claw clasps (130) depending from outer surfaces (128). On an outer circumferential wall (124), the figure-eight clasp is provided. Thus, the separate elements (a connector clasp and figure-eight clasp) are affixed to separate surfaces. Though some of the elements of the present invention are disclosed, the combination of the elements in the arrangement of the present invention are not disclosed and are not suggested or taught as being desirable by the Williams reference. In fact, the Williams reference teaches away from the present invention, since failure of the lobster claw clasp(s) to hold a chain or strand would result in the chain or strand being released from the jewelry piece. The figure-eight clasp is not utilized as a safety guard or back-up to the connector clasp.

Another reference considered relevant is U.S. Pat. No. 6,349,453 (Nicoletti et al.), which discloses a jewelry connector having a pin (8) and a safety spring clip (6) that is used as a back-up for the pin (8) coupling. Nicoletti et al. discloses a very broad statement at Column 2, Lines 50-60, in stating that the spring clip (6) is known as a safety element and is used in conjunction with known clasps, thereby providing an additional safety element. However, the reference goes no further in disclosing that the spring clip (6) is envisioned for use with a connector clasp in a matter disclosed by the present invention. Based on the art, the only successful combinations of a clasp with a safety clip (6) of the Nicoletti et al. reference relates to the barrel or box clasps.

Other references disclose specific or related elements of the present invention, including various types of individual clasps. References disclosing hook clasp type elements include U.S. Pat. No. 341,608 (Seaman) and U.S. Pat. No. 4,458,393 (Pogharian et al.) among the many references available. References disclosing ring clasp type elements include U.S. Pat. No. 4,000,627 (Wahlbeck) and U.S. Pat. No. 4,543,692 (Ode et al.). References disclosing lobster claw type elements include U.S. Pat. No. 5,974,459, U.S. Pat. No. 6,027,213 and U.S. Pat. No. 6,520,635 (Ignatowski), and U.S. Pat. No. 3,956,804 (Gatof et al.). References disclosing figure-eight type elements include: U.S. Pat. No. 4,426,854 (Geldwerth et al.); U.S. Pat. No. 4,520,537 (Valikov); U.S. Pat. No. 4,530,221 (Weinberg); U.S. Pat. No. 4,543,692 (Ode et al.); U.S. Pat. No. 6,112,373 (Steinhauer et al.); U.S. Pat. No. 6,349,453 (Nicoletti et al.); and U.S. Pat. No. 6,754,938 (Savoulidou). However, and reiterating the points made previously, these references, separately or in combination, fail to disclose the elements of the present invention as arranged in the claims. Thus, the present invention is patentably distinguishable over the prior art referenced above.

The inventor has worked within the jewelry industry for approximately twelve years devoted mainly to selling and repair of jewelry clasps. The inventor is unaware of any other apparatus or device that is similar to the present invention with regard to physical structure and/or the advantages and features provided described below. The industry includes a multitude of clasps and connectors used for linking ends of chains or other types of jewelry, but none of the major manufacturers and sellers of clasps and connectors have offered a device like that of the present invention. And, with the lobster claw clasp experiencing structural failure through repeated usage, it is believed that additional measures are necessary and desired by the owner to protect expensive and potentially irreplaceable jewelry. The present invention offers such an improvement in the art of jewelry clasps, in particular, and in the field of connecting clasps in general. Thus, the present invention fulfills a need in the industry that has yet went unfulfilled.

### SUMMARY OF THE INVENTION

In one embodiment of the present invention, a clasp or connector apparatus is disclosed, the clasp or connector apparatus comprising a connector clasp having a selectively displaceable member, and a safety clasp coupled to the connector clasp externally adjacent to the displaceable member. The connector clasp comprises means for selectively displacing the member. The safety clasp comprises a latch clasp, the latch clasp comprising a receiver coupled to the connector clasp, a joint coupled to the connector clasp spaced from the receiver, and an arm coupled to the joint and selectively movable for coupling to the receiver and aligning the arm parallel to the member.

In another embodiment of the present invention, a clasp or connector apparatus for coupling two segments of jewelry is disclosed, the clasp or connector apparatus comprising a connector clasp coupled to a first segment of the jewelry, the connector clasp manually openable for coupling to a second segment of the jewelry, and a latch clasp coupled to the connector clasp along an edge adjacent the connector clasp opening. The connector clasp comprises a body and a selectively displaceable member, the body and member defining a void formed therebetween for retaining the second segment, and means for selectively displacing the member. The latch clasp comprises a receiver coupled to the connector clasp, a joint coupled to the connector clasp spaced from the receiver, and an arm coupled to the joint and selectively movable for coupling to the receiver and aligning the arm adjacent to the member. The first segment may comprise a first end segment of the jewelry and the second segment may comprise a second end segment of the jewelry. Alternatively, the first segment may comprise a first intermediate segment of the jewelry and the second segment may comprise a second intermediate segment of the jewelry. Alternatively, the first segment or the second segment may comprise an end segment of the jewelry and the remaining first segment or second segment may comprise an intermediate segment of the jewelry.

In another embodiment of the present invention, a clasp or connector apparatus for coupling a lanyard to a ring is disclosed, the clasp or connector apparatus comprising a connector clasp coupled to an end of the lanyard, the connector clasp manually openable for coupling the lanyard to the ring, and a latch clasp coupled to the connector clasp along an edge adjacent the connector clasp opening. The connector clasp comprises a body and a selectively displaceable member, the body and member defining a void formed therebetween for retaining the second segment, and means for selectively displacing the member. The latch clasp comprises a receiver coupled to the connector clasp, a joint coupled to the connector clasp spaced from the receiver, and an arm coupled to the joint and selectively movable for coupling to the receiver and aligning the arm adjacent to the member.

In another embodiment of the present invention, a clasp system is disclosed, the clasp system comprising a first object comprising a connector clasp and a second object comprising a means for receiving the connector clasp. The connector clasp openable for coupling the first object to the coupling means of the second object. The system also includes a safety clasp coupled to the connector clasp. In one embodiment of the clasp system, the first object comprises a first segment of jewelry and the second object comprises a second segment of jewelry. In another embodiment of the clasp system, the first object comprises a lanyard and the second object comprises a ring. The connector clasp comprises a body and a selectively displaceable member. The connector clasp further comprising means for selectively displacing the member. The latch clasp comprises a receiver coupled to the connector clasp, a joint coupled to the connector clasp spaced from the receiver, and an arm coupled to the joint and selectively movable for coupling to the receiver and aligning the arm adjacent to the member.

In another embodiment of the present invention, a method of making a clasp or connector comprises the step of coupling a safety clasp to a connector clasp, the safety clasp aligned adjacent to a displaceable element of the connector clasp. In another embodiment of the present invention, a method of making an item of jewelry comprising the steps of coupling a safety clasp to a connector clasp for forming a jewelry connector, the safety clasp aligned adjacent to a displaceable element of the connector clasp, and coupling the jewelry connector to a segment of the jewelry.

As discussed above, the method and/or device of the present invention overcomes the disadvantages inherent in the prior art methods and devices. In this respect, before explaining at least one embodiment of the present invention in detail, it is to be understood that the invention is not limited in its application to the details of construction and to the arrangement of the components or elements set forth in the following description or as illustrated in the drawings. The invention is capable of other embodiments and of being practiced and carried out in various ways. Also, it is to be understood that the phraseology and terminology employed herein are for the purpose of description and should not be regarded as limiting the scope of the invention.

Accordingly, those skilled in the art will appreciate that the conception upon which this invention is based may readily be utilized as a basis for the design of other structures, methods, and systems for carrying out the purpose or purposes of the present invention. Therefore, it is important that the claims be regarded as including such equivalent constructions insofar as they do not depart from the spirit of the present invention.

Furthermore, the purpose of the foregoing “Abstract” is to enable the U.S. Patent and Trademark Office and the public, generally, and especially including the practitioners in the art who are not familiar with patent or legal terms or phraseology, to determine quickly from a cursory inspection, the nature and essence of the technical disclosure of the application. The “Abstract” is neither intended to define the invention of the application, nor is it intended to be limiting to the scope of the invention in any way. It is intended that the application is defined by the claims appended to this application.

### BRIEF DESCRIPTION OF THE DRAWINGS

Additional utility and features of the invention will become more fully apparent to those skilled in the art by reference to the following drawings, which illustrate the primary features of the preferred embodiment and numerous alternative embodiments.

FIG. 1 is a side view of a connector clasp known in the prior art, and specifically, of the lobster claw-type clasp;

FIG. 2 is a front or rear view of a safety clasp known in the prior art, and specifically, of the latch clasp variety having a figure-eight shape;

FIG. 3 is a front or rear view of a safety clasp known in the prior art, and specifically, of the latch clasp variety having a non-figure-eight shape;

FIG. 4 is a side view of one embodiment of a connector clasp of the present invention, the connector clasp including a safety clasp mounted outside of the primary clasp;

FIG. 5 is a front view of the connector clasp depicted in FIG. 4 illustrating one embodiment of the safety clasp utilized, a figure-eight shape latch clasp;

FIG. 6 is a front view of the connector clasp depicted in FIG. 4 illustrating another embodiment of the safety clasp utilized, a non-figure-eight shape latch clasp as an alternative to the latch clasp depicted in FIG. 5;

FIG. 7 is a side view of one embodiment of the connector clasp that may be utilized in the present invention, the connector clasp comprising a lobster-claw type clasp having a lever for moving or displacing the movable or displaceable element;

FIG. 8 is a side view of another embodiment of the connector clasp that may be utilized in the present invention, the connector clasp comprising a lobster-claw type clasp having a single push button for moving or displacing the movable or displaceable element;

FIG. 9 is a side view of another embodiment of the connector clasp that may be utilized in the present invention, the connector clasp comprising a lobster-claw type clasp having two push buttons for moving or displacing the movable or displaceable element;

FIG. 10 is a side view of another embodiment of the connector clasp that may be utilized in the present invention, the connector clasp comprising a spring bolt clasp (or alternatively a bolt spring clasp) having a wing for moving or displacing the movable or displaceable element;

FIG. 11 is a side view of another embodiment of the connector clasp that may be utilized in the present invention, the connector clasp comprising a spring hook having a returnably resilient and displaceable element;

FIG. 12 is a side view of another embodiment of the connector clasp that may be utilized in the present invention, the connector clasp comprising a carabiner having a movable and displaceable element, the element coupled to the carabiner via a hinge or spring;

FIG. 13 is a front view of another embodiment of the safety clasp that may be utilized in the present invention, the safety clasp that may comprise either a figure-eight shape or a non-figure eight shape, and the receiver and safety clasp are frictionally impinged so that the receiver is aligned away from the free end of the safety latch, and closer to the middle of the safety latch;

FIG. 14 is a front view of another embodiment of the safety clasp that may be utilized in the present invention, the safety clasp that may comprise either a figure-eight shape or a non-figure eight shape, and either safety clasp having an aperture formed at the free end of the safety latch of the solid or predominantly solid body latch, and the receiver and safety clasp are frictionally impinged so that the receiver is aligned away from the free end of the safety latch, and closer to the middle of the safety latch;

FIG. 15 is a front view of a connector or clasp system comprising the connector clasp and safety clasp utilized in coupling two segments of an object or item, wherein the two segments are respective ends of the jewelry;

FIG. 16 is a front view of an alternative embodiment of the system of FIG. 15, wherein the two segments are intermediate segments of the jewelry;

FIG. 17 is a front view of an alternative embodiment of the system of FIG. 15, wherein the two segments are an end segment and an intermediate segment, respectively, of the jewelry;

FIG. 18 is a side view of an alternative embodiment of the system of FIG. 15, wherein the two segments are a lanyard and a ring or hoop.

FIG. 19 is a side view of an alternative embodiment of the system of FIG. 15, wherein the two segments are a post and a link of a cuff link set.

### DETAILED DESCRIPTION OF THE EXEMPLARY EMBODIMENTS

The detailed description set forth below is for exemplary embodiments and is intended to explain the present invention. It is to be understood that a variety of other arrangements are also possible without departing from the spirit and scope of the present invention.

To better explain the exemplary embodiments disclosed below, the following words or phrases are used for describing various elements of the exemplary embodiments, including:

Claw-type clasp: depicted in FIG. 1, a clasp C having a body B and further having a curvilinear end in the form of a hook element H and a movable or displaceable element E communicating with the hook element H. The movable/displaceable element E is manipulated to provide ingress and egress to the area or region A inside of the hook element utilized to retain an object or item. The clasp C may include a means M (such as a lever) for moving or displacing element E. The claw-type clasp C may include the following clasps known in the various industry by specific labels, such as lobster claw type clasps, single or double push lock type clasps, snap bolts or bolt snaps (interchangeably used), snap hooks and carabiners, among other types of claps. The lobster claw type clasps may also include many variations, including standard lobster claws with or without jump rings, tear drop with or without jump rings, trigger clasp, lobster claw with swivel, infinity or figure-eight shaped lobster claw, oval cast clasp, dolphin shaped, heart shaped, among the many varieties available.

Safety or latch-type clasp: depicted in FIG. 2 or FIG. 3, a clasp S utilizing a joint or hinge J for moving latch S that is coupled to a receiver R, usually a fixed ball or knob, opposite to and in spaced relationship to the hinge or point of rotation of the latch. Some examples of the latch-type clasp include a figure-eight F type latch clasp (so-named for its figure-eight shape) or non-figure-eight N type latch clasps. The narrowed portion or end of the latch-type clasp (at an end opposite the hinge or point of rotation) is frictionally impinged about the ball or knob.

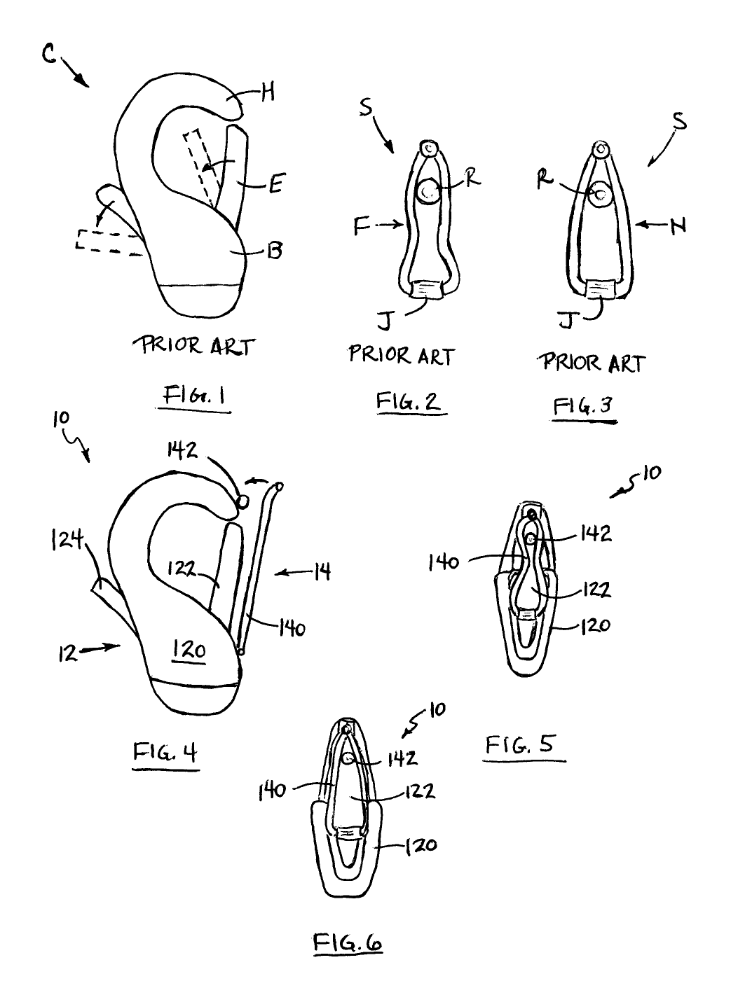

Referring now to FIG. 4 through FIG. 13, one embodiment depicts a clasp or connector 10 comprising a connector clasp 12 and a safety clasp 14 coupled to the connector clasp 12. The connector clasp 12 comprises a body 120, a movable or displaceable element 122, and means 124 for moving or displacing the element 122. The safety clasp 14 comprises a pivotal clasp 140 and a receiver 142 for receiving and coupling with the clasp 140. The safety clasp 14 is mounted to the connector clasp 12 so that the safety clasp 14 is adjacent the element 122. Thus, the connector clasp 12, generally, and the element 122, specifically, functions as the primary means for retaining a portion of jewelry, a fixed ring, or other similar component used for securing objects or items, and the safety clasp 14, generally, and the clasp 140 and receiver 142, specifically, functions as the secondary means for retaining the portion retained by the element 122. The element 122 may be generally described as a selectively movable or displaceable element or member, or more specifically, a selectively movable or displaceable leg of the connector clasp 12.

The connector clasp 12 may comprise a variety of structures, including those depicted in FIG. 4 through FIG. 6, and FIG. 7 through FIG. 12, respectively. Related variations generally include claw-type clasps, and further include a lobster-claw clasp 12a, a single push lock or double push lock clasp 12b, and a snap bolt (or alternatively named, a bolt snap) 12c. Each clasp 12a, 12b and 12c has a body 120, a movable or displaceable element 122, and means 124 for moving or displacing the element 122. In each clasp 12a, 12b and 12c, the body 120 has a hook or curvilinear segment that cooperates and complements the element 122 to form an enclosure (and may be further characterized as resulting in a void 130) that retains a portion of jewelry, a fixed ring, or other similar components used for securing objects or items. Means 124 for moving or displacing the element 122 may have a variety of structures and forms, including the lever 124a of clasp 12a, the single or double push lock 124b of clasp 12b, and the slidable wing 124c of clasp 12c, respectively.

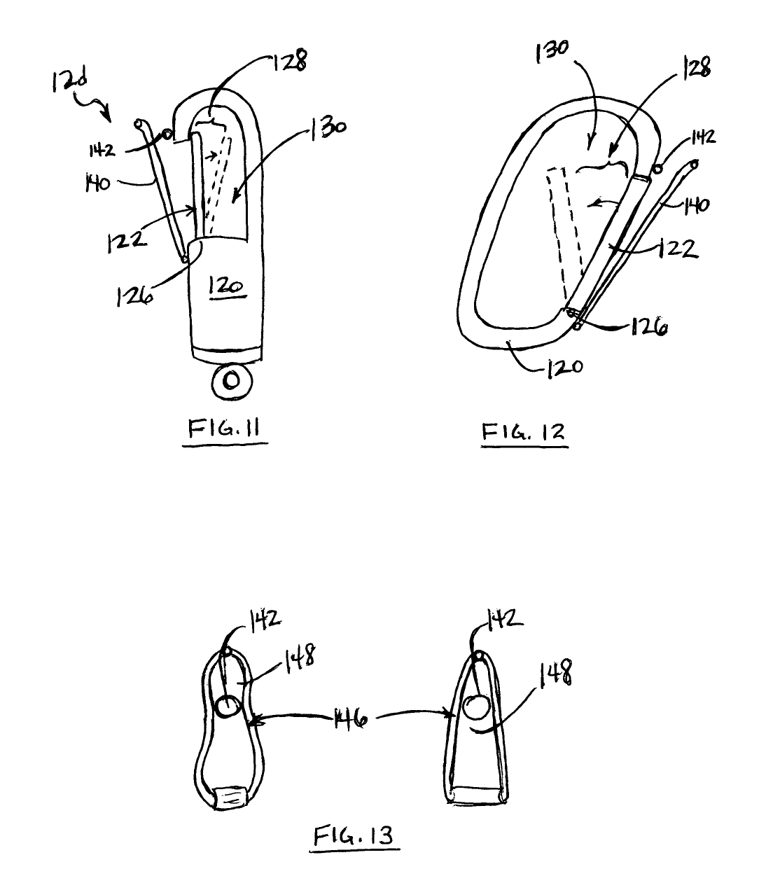

Another variation of the claw-type clasp 12 described above includes a snap hook 12d comprising a body 120 and a movable or displaceable element 122 (see FIG. 11). The element 122 may be moved or displaced by the application of force onto the element 122. The element 122 may be returnably resilient. Another variation includes a carabiner 12e comprising a body 120 and a movable or displaceable element 122 (see FIG. 12). The element 122 of either clasp 12d or 12e may be returnably resilient, and may be configured so that the element 122 is coupled to the body 120 via an outwardly biased hinge 126 or other means for pivoting the element 122 to and from engagement with the hook or curvilinear portion of body 120. In all the variations noted, clasps 12a through 12e, the movable or displaceable element 122 may be manipulated so as to form an opening 128 that allows for ingress and egress of the object or item to be retained by the clasp 12a, 12b, 12c, 12d or 12e (into the void 130).

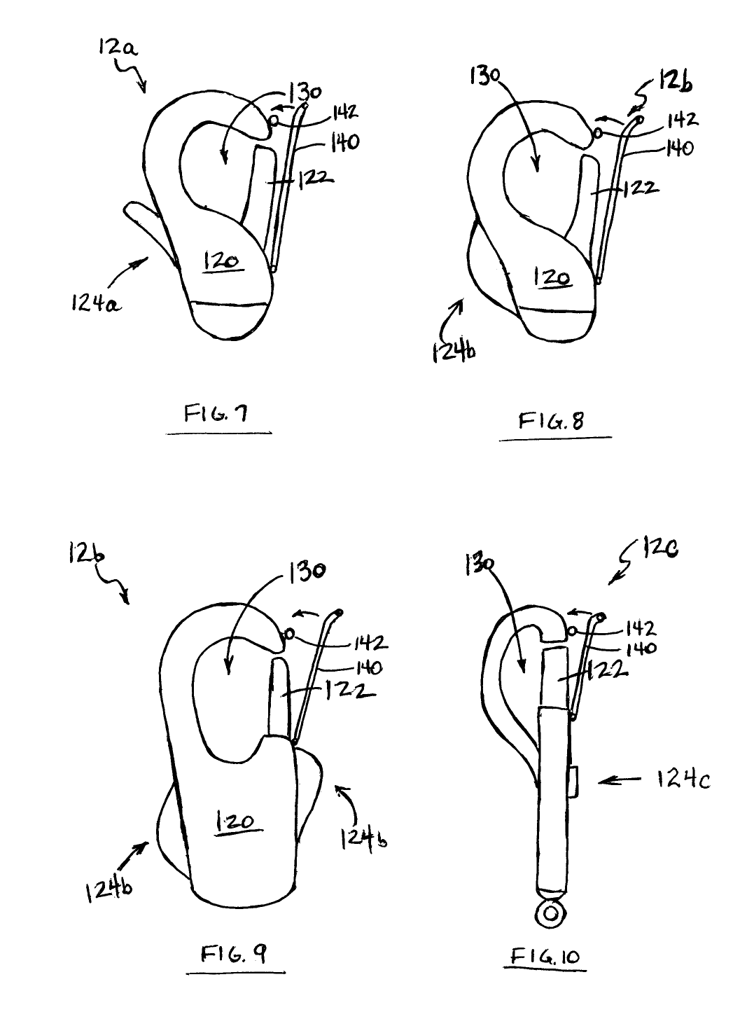

In the aforementioned embodiments of the claw-type clasp 12, including embodiments 12a through 12e, the safety clasp 14 (described in more detail below) is aligned externally adjacent to the element 122, so that the safety clasp 14 is the exterior or outer clasp and the claw clasp 12 is the interior or inner clasp. This alignment is particularly illustrated in FIG. 4, FIG. 5 and FIG. 6. It is also envisioned that the receiver 142 may be mounted at the hook element of the clasp 12 or at the base subjacent to the element 22.

The safety clasp 14 may be described as a latch-type clasp, generally, and may comprise a variety of structures, including a figure-eight type clasp 14a and a non-figure-eight type clasp 14b. As depicted in FIG. 2, FIG. 5 and FIG. 13, respectively, the figure-eight type clasp 14a is well-known in the art, and may be described using a number of labels, including a “figure-eight”, a “figure-of-eights”, or more generically as a spring clip or clasp, or as a safety clip or clasp since this clasp is usually employed as a secondary or safety clasp for the primary clasp device utilized. As depicted in FIG. 3, FIG. 6 and FIG. 13, respectively, the non-figure-eight type clasp 14b differs from the figure-eight type clasp 14a primarily based on the shape of the clasp 14b. Generally, the clasp 14a and/or 14b will have a wide end (at a hinge or hinges, for instance) and a narrow portion and/or end that will frictionally couple with the receiver 142 so that the clasp 14a or 14b frictionally impinges onto and is retained by the receiver 142. It is envisioned that the latch clasp 14 (and variations 14a and 14b) may comprise additional variations, including the frame-type depicted in FIG. 5 and FIG. 6, or a solid body type having an aperture 148 formed at the narrow portion and/or end for coupling with the receiver 142 (see FIG. 14). The aperture 148 may be integral to the narrow portion and/or end, so that the aperture 148 is defined by the narrow portion and/or end, or the aperture 148 may be formed on the underside of the latch clasp 14.

More specifically, the safety clasp 14 may comprise a latch clasp, the latch clasp comprising a receiver 142 coupled to the connector clasp 12. A joint 144 may be coupled to the connector clasp 12 spaced from the receiver 142. An arm 146 may be coupled to the joint 144 and selectively movable for coupling to the receiver 142 in the frictionally impinged manner described above, and aligning the arm 146 adjacent, and in some circumstances parallel, to the displaceable element or member 122 of clasp 12. The receiver 142 may have a variety of forms or shapes, including the general form of a projection or protrusion depending from the connector clasp 12 after coupling. More particularly, the projection or protrusion may have the form of a ball, knob, block or other geometric configuration that allows the receiver 142 to frictionally impinge and engage the narrow end of the clasp 14, and more particularly, the narrow portion and/or end of the arm 146 and the aperture 148 formed at the narrow portion and/or end of the arm 146. As is depicted in FIG. 13, the figure-eight clasp may frictionally impinge with the receiver 142 at a distance away from the free end (such as near the middle of the figure-eight), and the non-figure eight may as well, usually dictated by the circumference and diameter of the receiver 142. The joint 144 may comprise a variety of forms, including the use of any variety of hinge or hinges, or hinge-equivalent(s), that allows the clasp 14, and more particularly the arm 146, to selectively move between an open (non-engaged) position and a closed (engaged) position.

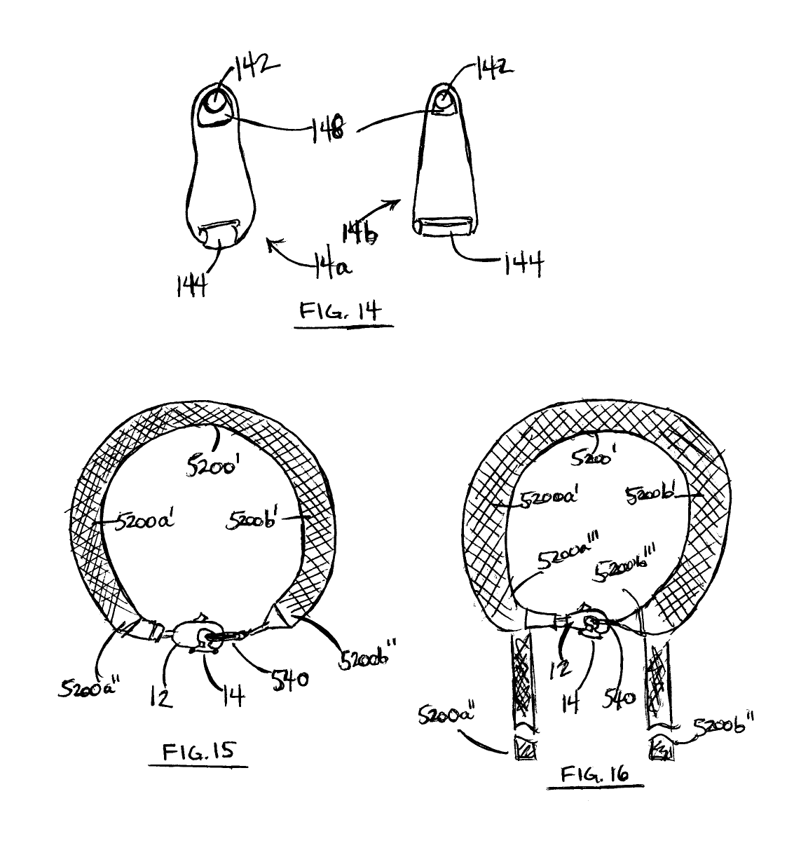

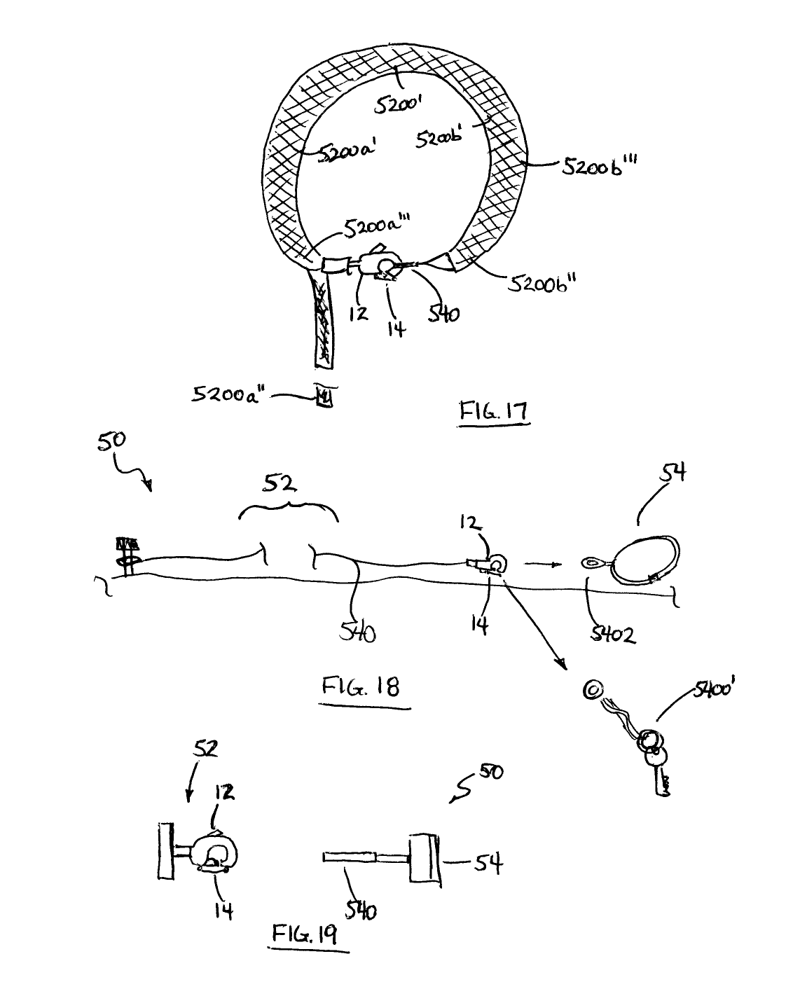

In another embodiment of the clasp or connector 10, and as depicted in FIG. 15, FIG. 16 and FIG. 17, a connector or clasp apparatus 10 for coupling two segments 5200a′ and 5200b′ of jewelry 5200′ is described. The clasp or connector apparatus 10 may comprise a connector clasp 12 coupled to one end segment 5200a″ or another end segment 5200b″ of the jewelry 5200′. The clasp or connector apparatus 10 may comprise a connector clasp 12 coupled to one intermediate segment 5200a′″ or another intermediate segment 5200b′″ of the jewelry 5200′. The connector clasp 12 may be manually openable for coupling to the remaining other segment 5200a′ or 5200b′, including coupling respective end segments together, respective intermediate segments together, or an end segment coupled to an intermediate segment. The connector clasp 12 is coupled to receiving or coupling means A latch clasp 14 may be coupled to the connector clasp 12 along an edge adjacent and external to the opening of connector clasp 12.

In another embodiment of the clasp or connector apparatus 10 for coupling a lanyard 5400 to a ring 5402 is described. The clasp or connector apparatus 10 comprises a connector clasp 12 coupled to an end of the lanyard 5400. The connector clasp 12 may be manually openable for coupling the lanyard 5400 to the ring 5402. A latch clasp 14 may be coupled to the connector clasp 12 along an edge adjacent and external to the opening of the connector clasp 12.

In another embodiment, as depicted in FIG. 18 and FIG. 19, a clasp system 50 is described, the system 50 comprising a first object or item 52 and a second object or item 54. The first object or item 52 comprises a connector clasp 520. The second object or item 54 comprises means 540 for receiving and coupling with the connector clasp 520. The connector clasp 520 is openable for coupling the first object or item 52 to the receiving means 540 of the second object or item 54. A latch clasp 522 is coupled to the connector clasp 520 along an edge adjacent and external to the opening of the connector clasp 520. In one aspect of this embodiment, the first object or item 52 comprises a first segment 5200a of jewelry 5200′ and the second object or item 54 comprises a second segment 5200b of jewelry 5200′. The segments 5200a and 5200b may include coupling of two end segments, coupling of two intermediate segments, or the coupling of an end segment to an intermediate segment. The first segment 5200a may also comprise one of either the post or the link elements of a set of cuff links (as depicted in FIG. 19). In another aspect of this embodiment, the first object or item 52 comprises a lanyard 5400 and the second object or item 54 comprises a ring 5402. In another aspect of this embodiment, the first object or item 52 may comprise a variety of objects, such as a key ring or fob 5400′, a wallet, a business card case, and other similar objects and the second object or item 54 comprises a ring 5402.

Receiving means 540 may comprise a variety of apparatuses or devices, including varieties of a ring, a swivel, an end cap, and an eye-bolt, and further including substitutes or equivalents of a swivel and/or end cap utilized in an item of jewelry. Ring varieties may include circular hoops or loops or D-rings coupled to a fixed object by a separate device, or coupled to a fixed object by adhesive or weld. An eye-bolt or similar eyelet is also envisioned as one possible embodiment.

It is also envisioned that several methods of making, fabricating or manufacturing the aforementioned embodiments may be utilized. For instance, a method for making a clasp or connector may comprise the step of coupling a safety clasp 14 to a connector clasp 12 or the types and variations described above, wherein the safety clasp 14 may be adhered, soldered, welded or otherwise affixed to the connector clasp 12 in a manner consistent with the configurations described above.

It is further envisioned that another method of making a clasp or connector may comprise the steps of forming a connector clasp 12, forming a safety clasp 14, and then coupling the safety clasp 14 to the connector clasp 12. The safety clasp 14 may be coupled to the connector clasp 12 by adhering, soldering, welding or otherwise affixing to a portion or the connector clasp 12.

It is further envisioned that another method of making a clasp or connector may comprise the steps of acquiring a connector clasp and acquiring a safety clasp, which may be accomplished by making each clasp or by purchasing each clasp, or by making one of the clasps and purchasing one of the clasps. After acquiring the clasps, the safety clasp 14 is coupled to the connector clasp 12, which may be accomplished by adhering, soldering, welding or otherwise affixing the safety clasp 12 to the connector clasp 12.

Related to the aforementioned methods described above are various methods for making an item of jewelry. In one such method, a method for making an item of jewelry comprises the step of coupling a connector clasp 12 having a safety clasp 14 coupled thereto to a segment of the jewelry, wherein the segment may comprise an end or a segment intermediately disposed between the respective ends of the jewelry. In another embodiment, a method for making an item of jewelry comprises the steps of coupling a safety clasp 14 to a connector clasp 12, such as by adhering, soldering, welding or otherwise affixing the safety clasp 14 to the connector clasp 12 in a manner consistent with the configuration(s) described above, and coupling the connector clasp 12 to an end of the jewelry. Other related methods include the forming of one or more clasps 12 and 14, and coupling the safety clasp 14 to the connector clasp 12 in a manner consistent with the methods described above. Another related method includes the acquisition of one or more of the clasps 12 and/or 14, and coupling the safety clasp 14 to the connector clasp 12 in a manner consistent with the methods described above.

It is envisioned that a number of materials, separately or in combination, may be suitable for use with one or more of the elements described and claimed in accordance with the embodiments disclosed herein. For jewelry, gold, silver, platinum and other precious and valuable metals may be used for one or more of the elements of each embodiment described. For non-jewelry items, it is envisioned that metal, plastic and other suitably durable materials may be used therewith.

While the invention has been described by way of example and in terms of several embodiments, it is to be understood that the invention is not limited to the embodiments disclosed herein. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A connector comprising:
a connector clasp having a selectively displaceable member; and
a safety clasp coupled to the connector clasp externally adjacent to the displaceable member.

2. The connector of claim 1, wherein the connector clasp comprises means for selectively displacing the member.

3. The connector of claim 1, wherein the safety clasp comprises a latch clasp, the latch clasp comprising:
a receiver coupled to the connector clasp;
a joint coupled to the connector clasp spaced from the receiver; and
an arm coupled to the joint and selectively movable for coupling to the receiver and aligning the arm parallel to the member.

4. A clasp for coupling two segments of jewelry, the clasp comprising:
a connector clasp coupled to a first segment of the jewelry, the connector clasp manually openable for coupling to a second segment of the jewelry; and
a latch clasp coupled to the connector clasp along an edge adjacent the connector clasp opening.

5. The clasp of claim 4, wherein the connector clasp comprises:
a body and a selectively displaceable member, the body and member defining a void formed therebetween for retaining the second segment;
means for selectively displacing the member.

6. The clasp of claim 4, wherein the first segment comprises a first end segment of the jewelry and the second segment comprises a second end segment of the jewelry.

7. The clasp of claim 4, wherein the first segment comprises a first intermediate segment of the jewelry and the second segment comprises a second intermediate segment of the jewelry.

8. The clasp of claim 4, wherein the first segment or the second segment comprises an end segment of the jewelry and the remaining first segment or second segment comprises an intermediate segment of the jewelry.

9. The clasp of claim 4, wherein the latch clasp comprises:
a receiver coupled to the connector clasp;
a joint coupled to the connector clasp spaced from the receiver; and
an arm coupled to the joint and selectively movable for coupling to the receiver and aligning the arm adjacent to the member.

10. A clasp for coupling a lanyard to a ring, the clasp comprising:
a connector clasp coupled to an end of the lanyard, the connector clasp manually openable for coupling the lanyard to the ring; and
a latch clasp coupled to the connector clasp along an edge adjacent the connector clasp opening.

11. The clasp of claim 10, wherein the connector clasp comprises:
a body and a selectively displaceable member, the body and member defining a void formed therebetween for retaining the second segment;
means for selectively displacing the member.

12. The clasp of claim 10, wherein the latch clasp comprises:
a receiver coupled to the connector clasp;
a joint coupled to the connector clasp spaced from the receiver; and
an arm coupled to the joint and selectively movable for coupling to the receiver and aligning the arm adjacent to the member.

13. A clasp system comprising:
a first object comprising a connector clasp;
a second object comprising a means for receiving the connector clasp;
the connector clasp openable for coupling the first object to the coupling means of the second object; and
a safety clasp coupled to the connector clasp (along an edge adjacent the connector clasp opening).

14. The clasp system of claim 13, wherein:
the first object comprises a first segment of jewelry; and
the second object comprises a second segment of jewelry.

15. The clasp system of claim 13, wherein:
the first object comprises a lanyard; and
the second object comprises a ring.

16. The clasp system of claim 13, wherein the connector clasp comprises:
a body; and
a selectively displaceable member.

17. The clasp system of claim 16, the connector clasp further comprising means for selectively displacing the member.

18. The clasp system of claim 13, wherein the latch clasp comprises:
a receiver coupled to the connector clasp;
a joint coupled to the connector clasp spaced from the receiver; and
an arm coupled to the joint and selectively movable for coupling to the receiver and aligning the arm adjacent to the member.

19. A method of making a clasp or connector comprising the step of coupling a safety clasp to a connector clasp, the safety clasp aligned adjacent to a displaceable element of the connector clasp.

20. The method of claim 19, wherein the clasp or connector forms an element of an item of jewelry, the safety clasp and the connector clasp for forming a jewelry connector.
